(19) United States
(12) Patent Application Publication
(10) Pub. No.: US 2006/0279023 A1
(43) Pub. Date: Dec. 14, 2006

(54) Precision loader of injection molds

(76) Inventor: Thomas J. Walsh, Hudson, WI (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/187,583

(22) Filed: Jul. 22, 2005

Related U.S. Application Data
(60) Provisional application No. 60/688,679, filed on Jun. 8, 2005.

(51) Int. Cl. B29C 45/00

(52) U.S. Cl. 264/328.1; 425/190

(57) ABSTRACT

In one aspect, a method of precisely loading a component into an injection mold is disclosed. The method includes packing a component into a first receptacle in a nest plate assembly. The nest plate assembly is in a packing position during packing. The method includes transferring the nest plate assembly from the packing position to a loading position via a guide rail system. The guide rail system includes a guide rail that extends from the packing position to the loading position. The method includes precision aligning the first receptacle with a second receptacle in a mold cavity. The method includes loading the component from the first receptacle into the second receptacle.

### CROSS-REFERENCE TO RELATED APPLICATION

This application claims priority under 35 U.S.C. § 119(e) to U.S. provisional application 60/688,679, filed Jun. 8, 2005, which is hereby incorporated by reference in its entirety.

### TECHNICAL FIELD

This document relates to injection molding and, more particularly, to precision loading of components for injection molding applications.

### BACKGROUND

In certain injection mold applications (e.g., overmolds), an injection mold must be loaded with a part/component before the mold closes and the component is overmolded. For instance, when injection molding poker chips, sometimes a metal slug is added to the final product to increase the final product's weight. In such instances, the metal slug may be loaded into the injection mold first, and then plastic is molded over the metal slug. In other situations, such as multi-shot products, a molded product is moved from one mold (e.g., the first shot) and loaded into a second mold (e.g., for the second shot).

When loading a mold (as discussed above), it is important to insert the metal slug or the first shot product into the injection mold (core/cavity mold) in a fairly precise location. That is, in the example provided above, if the metal slug is mistakenly loaded at an angle, the overmold may not work properly and may produce a faulty poker chip. Accordingly, manual loading of the injection molds often is not precise enough. Moreover, the time required for the operator to load the mold may be inconsistent.

Automated, precision loaders are often used. At least three different types of precision loaders are known: articulating programmable robots (e.g., 5-axis robots), side-entry multi-axis robots, and top-entry multi-axis robots.

Programmable robots may provide precision loading. An end-of-arm-tool in the form of a “nest insert” may be attached to a robot arm. The nest insert may have several cavities or recesses into which the components (e.g., slugs) may be manually loaded. The arm may be programmed to move the nest insert into alignment with the mold cavity where the robot then precision loads the mold cavity. The robot can provide a blast of air or a mechanical function to push the components out from each nest insert into the cavity. However, due to the forces required the robot arms may lack both the required force and rigidity to precision load the components into the injection mold. Shoving the components into the tightly-clearanced mold cavity may require a relatively large amount of force. Robot arms often require additional components to provide the needed force. And, as would be expected, such robots are expensive and they require a substantial amount of time to install and program for the particular application.

### SUMMARY

In one aspect, a method of precisely loading a component into an injection mold is disclosed. The method includes packing a component into a first receptacle in a nest plate assembly. The nest plate assembly is in a packing position during packing. The method includes transferring the nest plate assembly from the packing position to a loading position via a guide rail system. The guide rail system includes a guide rail that extends from the packing position to the loading position. The method includes precision aligning the first receptacle with a second receptacle in a mold cavity. The method includes loading the component from the first receptacle into the second receptacle.

Some embodiments of the method of precisely loading a component into an injection mold may have one or more of the following features. Loading the component may include pressing the mold cavity against the nest plate assembly while the component is being ejected from the nest plate assembly. The guide rail system may include a floating plate to which the mold cavity is releasably attached. The floating plate may press the mold cavity against the nest plate assembly. The guide rail system may include a mold carrier frame that is releasably attached to a stationary platen. The floating plate may move relative to mold carrier frame when pressing the mold cavity against the nest plate assembly. Loading the component may include actuating a transfer pin to eject the component from the nest plate assembly. Loading the component may include actuating a pneumatic cylinder to press the mold cavity against the nest plate assembly. The guide rail system may include a linear actuator to transfer the nest plate assembly from the packing position to the loading position. The linear actuator may include a pneumatic cylinder.

In a second aspect, an automatic transfer rail apparatus to precisely load a component into an injection mold is disclosed. The apparatus includes a guide rail system. The guide rail system includes a guide rail that extends between a packing position and a loading position. The guide rail system is configured to receive an attachable mold cavity. The apparatus includes a nest plate assembly. The nest plate assembly is configured to traverse along the guide rail between the packing position and the loading position. The nest plate assembly includes a first receptacle to receive a component during a packing operation at the packing position. The nest plate assembly includes a transfer mechanism to transfer the component from the nest plate assembly to the mold cavity during a loading operation.

Embodiments of the automatic transfer rail apparatus to precisely load a component into an injection mold may have one or more of the following features. The guide rail system may include a floating plate to which the mold cavity is releasably attachable. The floating plate may press the mold cavity against the nest plate assembly during the loading operation. The guide rail system may include a mold carrier frame that is releasably attached to a stationary platen. The floating plate may move relative to mold carrier frame when pressing the mold cavity against the nest plate assembly. The transfer mechanism may include a transfer pin to eject the component from the nest plate assembly. The guide rail system may include a pneumatic cylinder to press the mold cavity against the nest plate assembly during the loading operation. The guide rail system may include a linear actuator to traverse the nest plate assembly from the packing position to the loading position. The linear actuator may include a pneumatic cylinder.

In a third aspect, an injection-molding machine assembly for precisely loading a component into an injection mold is provided. The assembly includes an injection mold machine that has stationary and movable platens. The assembly includes an automatic transfer rail system, which includes a guide rail assembly and a nest plate assembly. The guide rail assembly includes a plate assembly and a guide rail that extends between a packing position and a loading position. The plate assembly is connectable to the stationary platen. The nest plate assembly is configured to traverse along the guide rail between the packing and loading positions. The nest plate assembly is configured to receive a component while in the packing position. The assembly includes a mold cavity. The mold cavity is configured to connect to the plate assembly and to receive the component from the nest plate assembly when the nest plate assembly is in the loading position.

Embodiments of the injection-molding machine assembly for precisely loading a component into an injection mold may provide one or more of the following features. The plate assembly may include a mold carrier frame to connect to the stationary platen. The plate assembly may include a floating plate to which the mold cavity is configured to connect. The floating plate may be configured to press the mold cavity against the nest plate assembly when the nest plate assembly is in the packing position. The floating plate may be movable relative to the mold carrier frame. The stationary platen may include a plurality of platen apertures and a sprue hole. The plate assembly may include, on one face of the plate assembly, a plurality of plate assembly bolts insertable into corresponding platen apertures and a first alignment ring insertable into the sprue hole. The plate assembly may include, on an opposed face of the plate assembly, a plurality of plate assembly apertures and an alignment ring receptacle. The mold cavity may include a plurality of mold cavity bolts insertable into corresponding plate assembly apertures and a second alignment ring insertable into the alignment ring receptacle. The plurality of plate assembly apertures and the alignment ring receptacle may be configured to provide an interface that is the same as an interface provided by the stationary platen.

In a fourth aspect, a method of assembling an injection mold machine is provided. The method includes connecting an automatic transfer rail system to a stationary platen of an injection molding machine. The automatic transfer rail system includes a guide rail assembly and a nest plate assembly. The guide rail assembly includes a plate assembly and a guide rail that extends between a packing position and a loading position. The plate assembly is connectable to the stationary platen. The nest plate assembly is configured to traverse along the guide rail between the packing and loading positions. The nest plate assembly is configured to receive a component while in the packing position. The method includes connecting a mold cavity to the automatic transfer rail system.

Embodiments of the method of assembling an injection mold machine may include one or more of the following features. The plate assembly may include a mold carrier frame to connect to the stationary platen. The plate assembly may include a floating plate to which the mold cavity is configured to connect. The floating plate may be configured to press the mold cavity against the nest plate assembly when the nest plate assembly is in the packing position. The floating plate may be movable relative to the mold carrier frame. Connecting the automatic transfer rail system to the stationary platen may include inserting a plurality of plate assembly bolts that are connected to the plate assembly into corresponding platen apertures in the stationary platen. Connecting the automatic transfer rail system to the stationary platen may include mating a plate assembly alignment ring with a platen alignment ring receptacle. Connecting the mold cavity to the automatic transfer rail system may include inserting a plurality of mold cavity bolts that are connected to the mold cavity into corresponding plate assembly apertures in the plate assembly. Connecting the mold cavity to the automatic transfer rail system may include mating a mold cavity alignment ring with a plate assembly alignment ring receptacle. The plate assembly apertures and the plate assembly alignment ring receptacle may be configured to provide an interface that is the same as an interface provided by the stationary platen.

Certain embodiments may have one or more of the following advantages. In some embodiments, injection molds may be precision molded in an inexpensive manner. In some embodiments, components may be loaded into injection molds with exceptional precision. Some embodiments may provide for a short setup time. Some embodiments may provide the force necessary to shove components into tightly-clearanced mold cavities. Some embodiments may transfer molded articles to multiple molding positions. Some embodiments could perform secondary functions like gate shearing, insert loading, and assembly of subsequent components.

### BRIEF DESCRIPTION OF THE DRAWINGS

FIGS. 1-3 show different perspective views of an injection molding module.

FIG. 4 shows a perspective view of an injection molding module.

FIG. 5 shows an exploded view of the injection molding module shown in FIG. 4.

FIGS. 6A and 6B show perspective views of a portion of an automatic transfer rail system connected to a mold cavity.

FIG. 7 shows a perspective view of an automatic transfer rail system.

FIG. 8 shows a perspective view of a portion of an automatic transfer rail system.

FIG. 9 shows an exploded top view of the injection molding module shown in FIG. 4.

FIGS. 10A and 10B show perspective views of a portion of an automatic transfer rail system.

### DETAILED DESCRIPTION OF ILLUSTRATIVE EMBODIMENTS

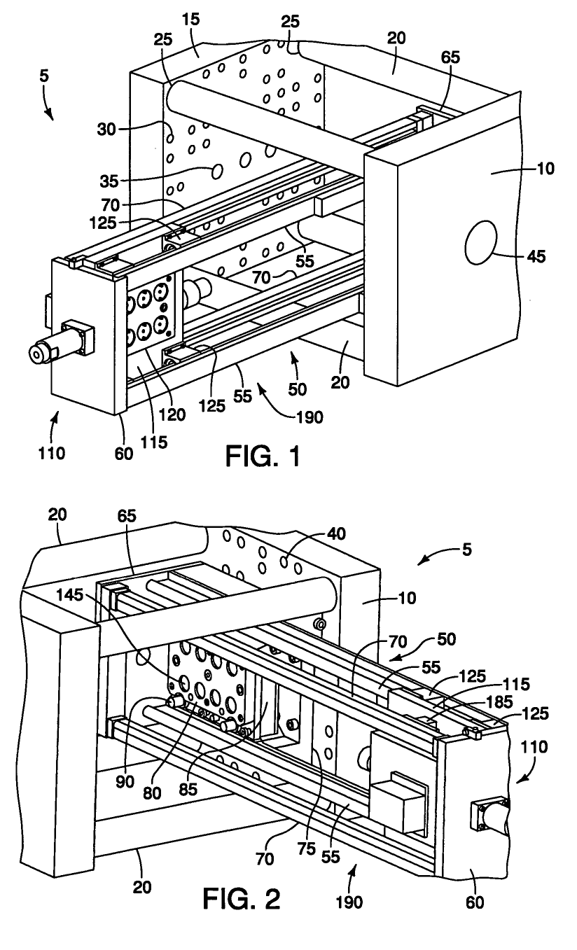

FIGS. 1-3 show perspective views of an exemplary injection molding module 5. The injection molding module 5 includes a stationary platen 10 and a movable platen 15. Tie bars 20 extend between the stationary platen 10 and the movable platen 15. The movable platen includes apertures 25 into which and through which the tie bars 20 extend. The movable platen 15 is able to move toward and away from the stationary platen 10 by sliding relative to the tie bars 20.

The movable platen 15, as shown in FIG. 1, includes a plurality of receptacles 30, 35 that are capable of receiving alignment members of, for example, a mold core. Such alignment members may be pins, bolts, or other suitable members. A mold core may use a combination of different types of alignment members. The receptacles 30, 35 may be threaded.

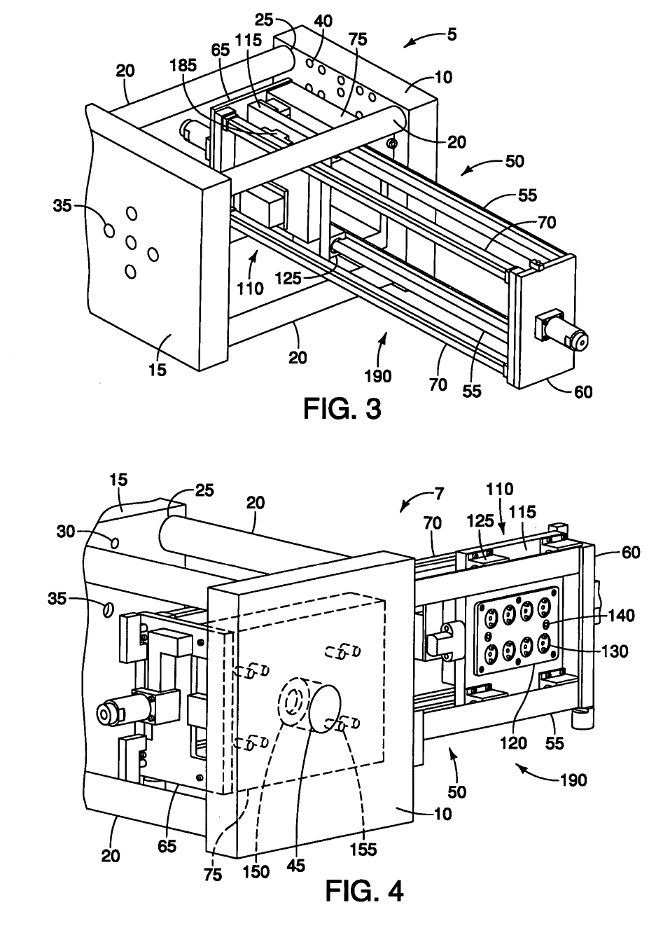

The stationary platen 10, as shown in FIGS. 2-3, includes a plurality of receptacles 40. And like the movable platen's 15 receptacles 30, 35, the stationary platen's 10 receptacles 40 are capable of receiving alignment members. The alignment members may align, for example, a mold cavity. The alignment members and the receptacles 40 may have the same or different attributes as those described in the preceding paragraph. The stationary platen also includes a sprue hole 45 through which resin may flow during an injection molding operation.

The injection molding module 5 shown in FIGS. 1-3 includes an automatic transfer rail (ATR) system 190, which includes a guide rail system 50 and a nest plate assembly 110. The guide rail system 50 includes guide rails 55, two opposed end plates 60, 65, and linear actuators 70. The end plates 60, 65 are generally parallel to each other, and all four of the guide rails 55 and the linear actuators 70 are generally parallel to each other. The end plates 60, 65, the guide rails 55, and the linear actuators 70 may be arranged in any suitable formation. The guide rails 55 and the linear actuators 70 attach on one end to one of the end plates 60 and on the other end to the other end plate 65. Although the guide rail system 50 shown in FIGS. 1-3 includes two guide rails 55, two linear actuators 70, and two end plates 60, 65, any suitable configuration may be used.

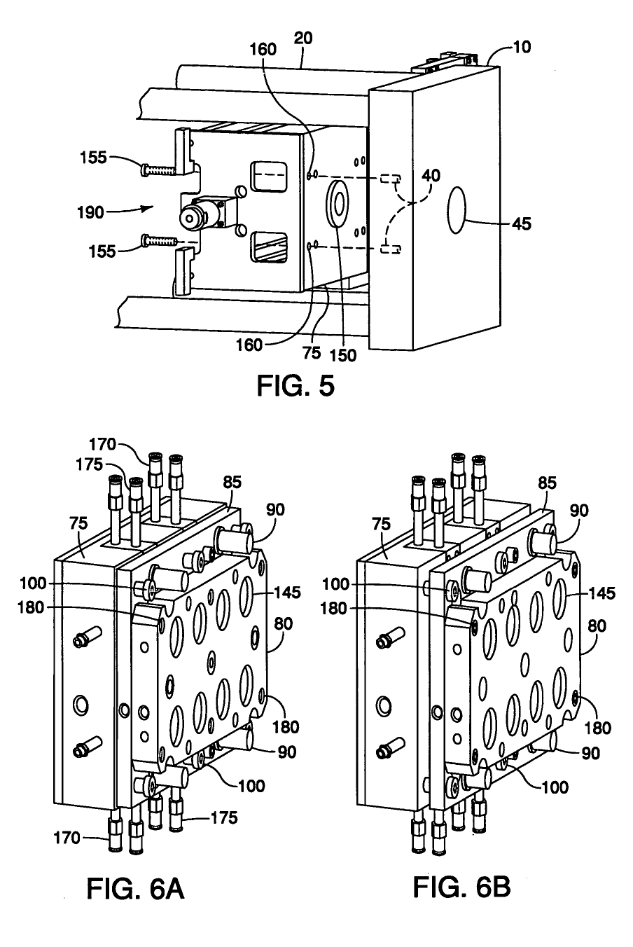

FIGS. 2-3 show the exemplary guide rail system 50 attached to the stationary platen 10. The guide rail system 50 includes a mold carrier frame 75, which is shown attached to the stationary platen 10. FIG. 4 shows an exemplary injection molding module 7 that differs from the injection molding module 5 of FIGS. 1-3 only in that the ATR system 190 extends outwardly from the tie bars 20 in the opposite direction. FIG. 5 provides a closer view of the injection molding module 7. Specifically, FIG. 5 shows how the exemplary mold carrier frame 75 attaches to the stationary platen 10. The mold carrier frame 75 includes an alignment ring 150. The alignment ring 150 is aligned with the sprue hole 45, and the mold carrier frame 75 is pressed against the stationary platen 10 such that the outer perimeter of the alignment ring 150 interfaces with the inner perimeter of the sprue hole 45. Bolts 155 are inserted through apertures 160 in the mold carrier frame 75 and into receptacles 40 to secure the mold carrier frame 75 to the stationary platen 10. Any other appropriate means to attach the mold carrier frame 75 can be used (e.g., toe-clamps). The guide rail system 50 may be detachable from the stationary platen 10.

FIGS. 6A and 6B show the mold carrier frame 75 coupled to a floating plate 85. The floating plate 85 may move relative to the mold carrier frame 75. The rear face of the floating plate 85 may move into and out of contact with the front face of the mold carrier frame 75. Throughout such movement, the rear face of the floating plate 85 may maintain a parallel relationship with the front face of the mold carrier frame 75. The movement of the floating plate 85 may be limited by shoulder bolts 100. The shoulder bolts 100 may be connected to the mold carrier frame 75 such that the shoulder bolts 100 are prohibited from moving relative to the mold carrier frame 75. The shoulder bolts 100 may be removable from the mold carrier frame 75. When the floating plate 85 is moved out of contact with the mold carrier frame 75, the front face of the floating plate 85 may contact the shoulder bolts 100, thereby preventing the floating plate 85 from moving any farther away from the mold carrier frame 75. The floating plate 85 may include guide pins 90 that are capable of insertion into corresponding apertures for alignment purposes.

Movement of the floating plate 85 relative to the mold carrier frame 75 may be actuated by varying air pressure delivered by pneumatic cylinders 170, 175. Increased air pressure in the rear pneumatic cylinders 170 may urge the floating plate 85 away from the mold carrier frame (see FIG. 6B). Increased air pressure in the front pneumatic cylinders 175 may urge the floating plate 85 toward the mold carrier frame 75 (see FIG. 6A). The air pressure delivered by the pneumatic cylinders 170, 175 may be controllable by any suitable controller. Other means of actuation for the floating plate 85 may include hydraulic and electric.

FIG. 2 shows a mold cavity 80 attached to the guide rail system 50. The mold cavity 80 is attached to the guide rail system's 50 floating plate 85. FIGS. 6A and 6B provide a closer view of the floating plate 85 and the mold cavity 80. The mold cavity 80 shown in FIGS. 6A and 6B is attached to the floating plate 85 by bolts 180 that extend through apertures in the mold cavity 80 into corresponding receptacles in the floating plate 85. The bolts 180 prevent the mold cavity 80 from moving relative to the floating plate 85. Thus, when the floating plate 85 moves relative to the mold carrier frame 75, the mold cavity 80 moves with the floating plate 85. The mold cavity 80 may be removable from the floating plate 85.

The floating plate 85 may be designed such that it provides a similar interface to that of the stationary platen 10, which may provide a standard interface. In such a configuration, mold cavities that are designed to align with the stationary platen 10 are also able to align with the floating plate 85. For example, the interface of the stationary platen 10 shown in FIGS. 4 and 5 includes a centrally-located circular receptacle defined by the sprue hole 45 and several smaller receptacles 40. The floating plate 85 may also be designed such that its front face includes a centrally-located circular receptacle and several smaller receptacles. In a configuration like the one described in this paragraph, the guide rail system 50 may essentially act as a spacer between the mold cavity 80 and the stationary platen 10.

The mold cavity 80 shown in FIGS. 6A and 6B has eight mold cavity receptacles 145. Each may be configured to receive a component to be molded over. Any number of mold cavity receptacles 145 may be provided. The mold cavity receptacles 145 may be situated in the mold cavity 80 in any suitable formation.

The nest plate assembly 110 of the ATR system 190 shown in FIGS. 1-3 includes a nest carrier 115 to which a nest plate 120, four gliders 125, and two actuator connectors 185 are attached. The gliders 125 couple the nest plate assembly 110 to the guide rails 55 and allow the nest plate assembly 110 to glide to various positions along the guide rails 55. The nest plate assembly 110 may be positioned in a packing location (see FIG. 2), in a loading position (see FIG. 3), or anywhere else along the guide rails 55. In the case of multi-shot applications, the nest plate 120 can position itself in numerous molding positions. The actuator connectors 185 couple the nest plate assembly 110 to the linear actuators 70, allowing the linear actuators 70 to move the nest plate assembly 110 along the guide rails 55. Examples of linear actuators include pneumatic cylinders, electric servo motors, hydraulic cylinders, and other suitable actuators. The linear actuators 70 may be controlled by any suitable controller.

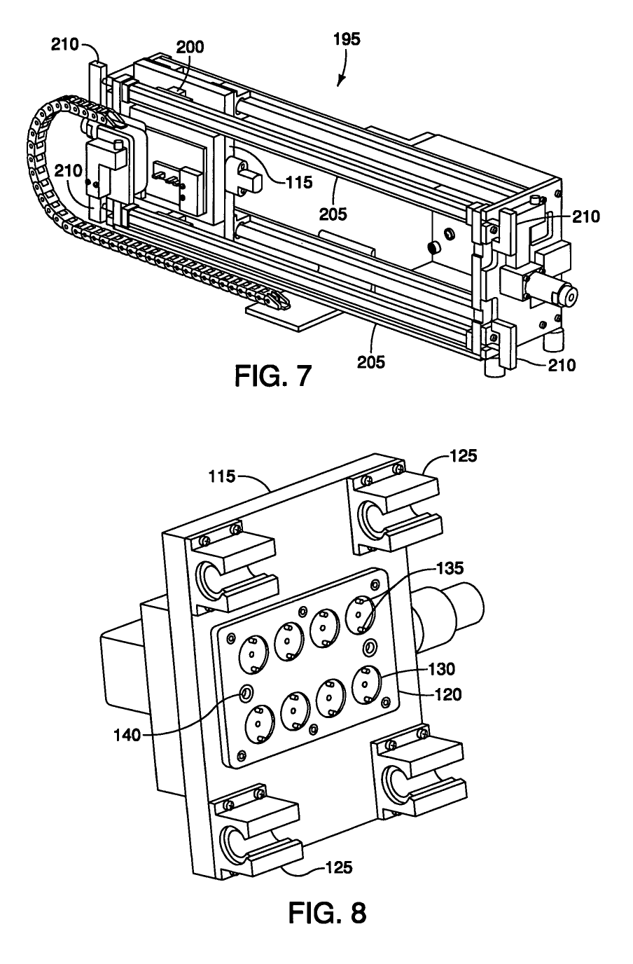

FIG. 7 shows an exemplary linear actuator assembly 195. The actuator connectors 200 are floating mounts. The floating mounts attach the nest carrier 115 to pistons. The pistons are housed within pneumatic cylinders 205. The pneumatic cylinders 205 are controlled by electronically activated pneumatic valves 210, which are located on either end of the pneumatic cylinders 205.

FIG. 8 provides a closer view of the nest plate 120 of FIGS. 1-3, along with the gliders 125 and the nest carrier 115. The nest plate 120 includes eight nest plate receptacles 130. Each nest plate receptacle 130 is configured to receive a component to be molded over. Each nest plate receptacle 130 includes two transfer pins 135, which are actuated by pneumatic cylinders. The transfer pins 135 push components from the nest plate receptacles 130. The nest plate 120 also includes alignment apertures 140 that are configured to receive alignment members to secure the nest plate assembly 110 in desired positions along the guide rails 55. Other methods of alignment can include straight parting line locks and tapered alignment in the cavity steel itself for instances where individual alignment is required for each individual cavity-core set. This may be required for extreme precision circumstances.

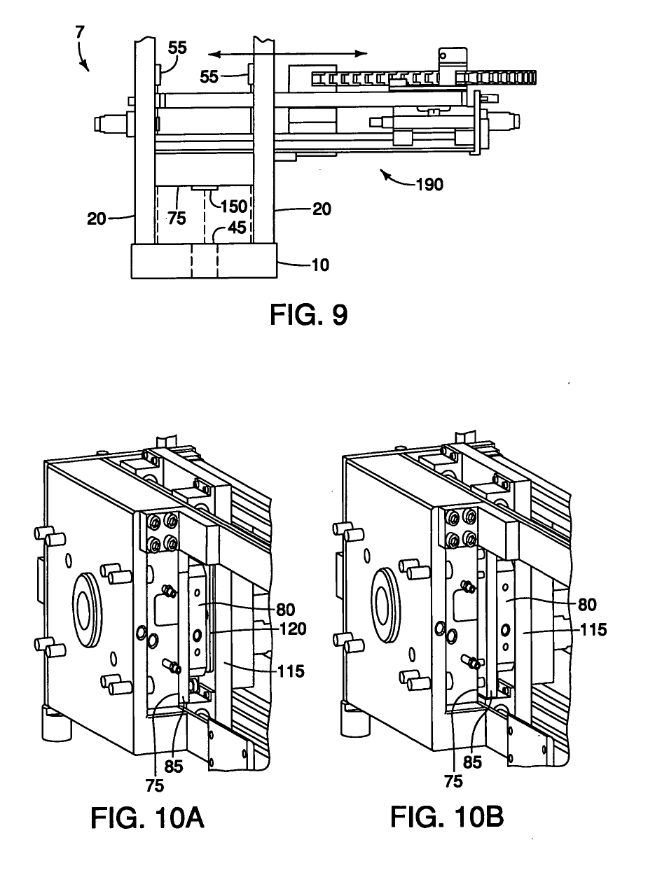

FIG. 9 illustrates how to assemble the exemplary injection molding module 7. The ATR system 190 may constitute a separate component from the stationary platen 10 and the tie bars 20. The ATR system 190 may be inserted between the tie bars 20 as shown by the arrow in FIG. 9. The alignment ring 150 may be aligned with the sprue hole 45, and the mold carrier frame 75 may be pressed against the stationary platen 10 such that the alignment ring 150 is inserted into the sprue hole 45. Bolts 155 may secure the ATR system 190 to the stationary platen 10.

In use, the nest plate assembly 110 of the ATR system 190 shown in FIGS. 1-3 may be positioned at the end of the guide rails 55 that is outside the area defined by the tie bars 20 and the platens 10, 15, in a packing position (see FIGS. 1 and 2). Components to be overmolded may be packed into the nest plate receptacles 130. The components may be packed into the nest plate receptacles 130 manually or by any suitable automated means.

After components are packed into the nest plate receptacles 130, the linear actuators 70 may move the nest plate assembly 110 along the guide rails 55 to the opposite end of the guide rail system 50, into a loading position (see FIG. 3). The nest plate 120 may be aligned with the mold cavity 80 such that each nest plate receptacle 130 is aligned with a corresponding mold cavity receptacle 145.

When the nest plate 120 and the mold cavity 80 are aligned, the components may be transferred from the nest plate 120 to the mold cavity 80, thereby loading the mold cavity 80. Loading may be accomplished by two things happening substantially simultaneously. The floating plate 85 may be rapidly moved away from the mold carrier frame 75 and, consequently, toward the nest plate 120, until the mold cavity 80 contacts the nest plate 120. FIG. 10A shows the floating plate 85 in a retracted position, and FIG. 10B shows the floating plate in an extended position. As the floating plate 85 is extending toward the nest plate 120, the transfer pins 135 (shown in FIG. 8) may be actuated to push the components from the nest plate receptacles 130 (shown in FIG. 8) into the mold cavity receptacles 145 (shown in FIGS. 6A and 6B). Once the transfer has occurred from the nest plate 120 to the floating plate 85, the floating plate 85 returns to its non-extended position, and the linear actuators move the nest plate 120 out of the molding area so that injection molding can occur.

Referring to FIG. 9, when overmolding applications are no longer desired, the ATR system 190 may be removed from the stationary platen 10. The bolts 155 may be removed, and the ATR system 190 may be pulled away from the stationary platen 10 and lifted out through the tie bars 20, as shown by the arrow. When the ATR system 190 is removed, the stationary and movable platens 10, 15, along with the tie bars 20 may be used for injection molding applications other than overmolding.

Certain embodiments of the precision loader of injection molds are disclosed. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. A method of precisely loading a component into an injection mold comprising:
packing a component into a first receptacle in a nest plate assembly, the nest plate assembly being in a packing position during packing;
transferring the nest plate assembly from the packing position to a loading position via a guide rail system, the guide rail system comprising a guide rail that extends from the packing position to the loading position;
precision aligning the first receptacle with a second receptacle in a mold cavity; and
loading the component from the first receptacle into the second receptacle.

2. The method of claim 1, wherein loading the component includes pressing the mold cavity against the nest plate assembly while the component is being ejected from the nest plate assembly.

3. The method of claim 2, wherein the guide rail system further comprises a floating plate to which the mold cavity is releasably attached, and wherein the floating plate presses the mold cavity against the nest plate assembly.

4. The method of claim 3, wherein the guide rail system further comprises a mold carrier frame that is releasably attached to a stationary platen, and wherein the floating plate moves relative to mold carrier frame when pressing the mold cavity against the nest plate assembly.

5. The method of claim 1, wherein loading the component comprises actuating a transfer pin to eject the component from the nest plate assembly and actuating a pneumatic cylinder to press the mold cavity against the nest plate assembly.

6. The method of claim 1, wherein the guide rail system further comprises a linear actuator to transfer the nest plate assembly from the packing position to the loading position.

7. The method of claim 6, wherein the linear actuator comprises a pneumatic cylinder.

8. An automatic transfer rail apparatus to precisely load a component into an injection mold, comprising:
a guide rail system including a guide rail that extends between a packing position and a loading position, the guide rail system being configured to receive an attachable mold cavity; and
a nest plate assembly configured to traverse along the guide rail between the packing position and the loading position, the nest plate assembly comprising a first receptacle to receive a component during a packing operation at the packing position and a transfer mechanism to transfer the component from the nest plate assembly to the mold cavity during a loading operation.

9. The apparatus of claim 8, wherein the guide rail system further comprises a floating plate to which the mold cavity is releasably attachable, and wherein the floating plate presses the mold cavity against the nest plate assembly during the loading operation.

10. The apparatus of claim 9, wherein the guide rail system further comprises a mold carrier frame that is releasably attached to a stationary platen, and wherein the floating plate moves relative to mold carrier frame when pressing the mold cavity against the nest plate assembly.

11. The apparatus of claim 8, wherein the transfer mechanism comprises a transfer pin to eject the component from the nest plate assembly, and wherein the guide rail system comprises a pneumatic cylinder to press the mold cavity against the nest plate assembly during the loading operation.

12. The apparatus of claim 8, wherein the guide rail system further comprises a linear actuator to traverse the nest plate assembly from the packing position to the loading position.

13. The apparatus of claim 12, wherein the linear actuator comprises a pneumatic cylinder.

14. An injection-molding machine assembly for precisely loading a component into an injection mold, comprising:
an injection mold machine having stationary and movable platens;
an automatic transfer rail system including a guide rail assembly and a nest plate assembly, the guide rail assembly including a plate assembly and a guide rail extending between a packing position and a loading position, the plate assembly being connectable to the stationary platen, the nest plate assembly being configured to traverse along the guide rail between the packing and loading positions, the nest plate assembly being configured to receive a component while in the packing position; and
a mold cavity configured to connect to the plate assembly and to receive the component from the nest plate assembly when the nest plate assembly is in the loading position.

15. The assembly of claim 14, wherein the plate assembly comprises a mold carrier frame to connect to the stationary platen and a floating plate to which the mold cavity is configured to connect, the floating plate being configured to press the mold cavity against the nest plate assembly when the nest plate assembly is in the packing position and being movable relative to the mold carrier frame.

16. The assembly of claim 14, wherein
the stationary platen comprises a plurality of platen apertures and a sprue hole;
the plate assembly comprises, on one face of the plate assembly, a plurality of plate assembly bolts insertable into corresponding platen apertures and a first alignment ring insertable into the sprue hole, and, on an opposed face of the plate assembly, a plurality of plate assembly apertures and an alignment ring receptacle; and
the mold cavity comprises a plurality of mold cavity bolts insertable into corresponding plate assembly apertures and a second alignment ring insertable into the alignment ring receptacle.

17. The assembly of claim 16, wherein the plurality of plate assembly apertures and the alignment ring receptacle are configured to provide an interface that is the same as an interface provided by the stationary platen.

18. A method of assembling an injection mold machine, comprising:
connecting an automatic transfer rail system to a stationary platen of an injection molding machine, the automatic transfer rail system including a guide rail assembly and a nest plate assembly, the guide rail assembly including a plate assembly and a guide rail extending between a packing position and a loading position, the plate assembly being connectable to the stationary platen, the nest plate assembly being configured to traverse along the guide rail between the packing and loading positions, the nest plate assembly being configured to receive a component while in the packing position; and
connecting a mold cavity to the automatic transfer rail system.

19. The method of claim 18, wherein the plate assembly comprises a mold carrier frame to connect to the stationary platen and a floating plate to which the mold cavity is configured to connect, the floating plate being configured to press the mold cavity against the nest plate assembly when the nest plate assembly is in the packing position and being movable relative to the mold carrier frame.

20. The method of claim 18, wherein connecting the automatic transfer rail system to the stationary platen comprises inserting a plurality of plate assembly bolts that are connected to the plate assembly into corresponding platen apertures in the stationary platen, and mating a plate assembly alignment ring with a platen alignment ring receptacle.

21. The method of claim 18, wherein connecting the mold cavity to the automatic transfer rail system comprises inserting a plurality of mold cavity bolts that are connected to the mold cavity into corresponding plate assembly apertures in the plate assembly and mating a mold cavity alignment ring with a plate assembly alignment ring receptacle.

22. The method of claim 21, wherein connecting the automatic transfer rail system to the stationary platen comprises inserting a plurality of plate assembly bolts that are connected to the plate assembly into corresponding platen apertures in the stationary platen, and mating a plate assembly alignment ring with a platen alignment ring receptacle.

23. The method of claim 21, wherein the plate assembly apertures and the plate assembly alignment ring receptacle are configured to provide an interface that is the same as an interface provided by the stationary platen.
